(19) United States
(12) Patent Application Publication
(10) Pub. No.: US 2005/0211061 A1
(43) Pub. Date: Sep. 29, 2005

(54) Percussion practice pad that helps develop and improve accuracy

(76) Inventors: Michael Theodore Passaris, Novato, CA (US); Sergio Brett Carreno, South Hampton, NY (US)

Correspondence Address: Michael T. Passaris, 110 La Merida Court, Novato, CA, 94945, US

(21) Appl. No.: 10/910,388

(22) Filed: Aug. 3, 2004

Related U.S. Application Data
(60) Provisional application No. 60/493,079, filed on Aug. 6, 2003.

(51) Int. Cl. G10H 7/00

(52) U.S. Cl. 84/411 P

(57) ABSTRACT

A percussion practice pad that helps develop and improve accuracy for a percussionist to improve their accuracy which will improve technique thus improving their sound. The inventive device includes a practice pad and a cap which can be attached and detached to the pad. This practice pad is made up of a circular piece of hard material with a circular piece of resilient material affixed to its upper side. There is a hole drilled in the middle of the practice pad which contains a fastening device from which to attach the cap. The cap is a cylindrical piece of hard material that may contain a piece of resilient material affixed to its upper side. The lower side has a threaded device that attaches the cap to the practice pad.

### DETAILED DESCRIPTION OF THE INVENTION

Turning now descriptively to the drawings, in which similar reference characters denote similar elements throughout the several views, the attached figures illustrate a percussion practice pad that helps develop and improve accuracy, which comprises a practice pad and a cap which can be attached and detached to the pad. This practice pad is made up of a circular piece of hard material with a circular piece of resilient material affixed to its upper side. There is a hole drilled in the middle of the practice pad which contains a fastening device from which to attach the cap. The cap is a cylindrical piece of hard material that may contain a piece of resilient material affixed to its upper side. The lower side has a threaded device that attaches the cap to the practice pad.

This practice pad is made up of a circular piece of hard material with a circular piece of resilient material affixed to its upper side. There is a hole drilled in the middle of the practice pad which contains a fastening device from which to attach the cap. Referring to FIGS. 1-4 the practice pad 10 is comprised of four primary components. The practice pad 10 is made up of a hard material 12 with a resilient material 14 affixed to its upper side. On its bottom side the practice pad 10 has a non-skid material 16 attached. In the center of the practice pad 10 there is a fastening device 18 which goes through the hard material 12, resilient material 14, and non-skid material 16. The hard material 12 shown in the figures is round, as preferred, however it would function just as well if it were any other shape, i.e. triangle, rectangle, or square. The hard material 12 is made of wood. Preferably a natural wood or naturally laminated wood, but particle board or fiber board may also be used. The piece of wood 12 should be approximately eight to fourteen inches in diameter and have a thickness of one-half inch to one inch. The resilient material 14, adhered to the upper side of the wood 12, is rubber. It is positioned in the center of the wood 12 and is between one to three inches smaller in diameter than the wood 12. The rubber 14 is between the thicknesses of one eighth of an inch to three quarters of an inch. The rubber used for the resilient material 14 can be natural pure gum rubber, but not excluding stamp rubber, neoprene, or Buna-N. The non-skid material 16 adheres to the bottom side of the hard material 12. This material can have a diameter of one inch to fourteen inches depending on the size of the hard material 12. It may also just be a ring spanning the diameter of the hard material 12 with the ring size being between one half of an inch to seven inches. The non-skid material 16 will have a thickness of one sixteenth of an inch thick to one half of an inch. The non-skid material 16 may also be tiny rubber squares, circles, triangles, or any other shapes adhered to the bottom of the hard material side of the hard material 12. In the center of the practice pad 10 there is a fastening device 18. This fastening device 18 will most likely have threads and be long enough to be flush with the bottom side of the hard material 12 and flush with the resilient material 14 on the top side of the hard material 12. The fastening device 18 will have a diameter of one eighth of an inch to one half of an inch. This device will most likely be a hex nut.

The cap is a cylindrical piece of hard material that may contain a piece of resilient material affixed to its upper side. The lower side has a threaded device that attaches the cap to the practice pad. Referring to FIGS. 3-7 the cap 20 is comprised of five components. The cap 20 is made up of a hard shell 22 with resilient material 28 affixed to its upper side and coated with an elastic substance 30. Inside the cap 20 there is a fastening device 24 which is cemented by an adhesive 26. The cap 20 as shown in the figures is round. The cap 20 is made of plastic, but it could very well be wood, any form of metal, or rubber. The cap 20 should be approximately three quarters of an inch in diameter to three inches in diameter. The cap 20 should be approximately one quarter of an inch tall to one and one half inches tall. The resilient material 28 affixed to the upper side of the cap 20 should have the same diameter as the top of the cap 20, three quarters of an inch to three inches. The resilient material 28 used is rubber. The rubber used can be a natural pure gum rubber, but not excluding stamp rubber, neoprene or Buna-N. The cap 20 is coated with an elastic substance 30. The elastic substance 30 coats the cap 20, the resilient material 28 affixed to the upper side of the cap 20, and can coat the adhesive 26 inside the cap 20. This elastic substance 30 is Plasti Dip, a rubber coating. The cap 20 is dipped or brushed with the elastic substance 30 several times approximately two to eight times. Inside the cap 20 is the fastening device 24 which is cemented by an adhesive 26. The fastening device 24 is approximately one half inch to one and one half inches in length. The fastening device 24 will have a diameter of one eighth of an inch to one half of an inch. This device will most likely be a bolt and have threads. The fastening device 24 is cemented in the center of the cap 20 and will protrude approximately one eighth of an inch to one half of an inch from the bottom of the cap 20 with the head of the fastening device 24 inside the cap 20 and the threads protruding from the bottom of the cap 20. The adhesive 26 is epoxy which will harden inside the cap 20 and hold the fastening device 24 in its proper place.

The practice pad 10 has a fastening device 18 in the center to provide a means of attaching the cap 20. The cap 20 also has a fastening device 24 to attach it to the practice pad 10. Both fastening devices 18, 24 will have threads to attach. The cap 20 will screw into the practice pad 10 through their respective fastening devices 18, 24. The practice pad 10 may have different resilient material 14 on its upper side, while the non-skid material 16 may also be different, but still achieve its primary use. The hard material 12 is preferred to be constructed of wood, but plastic, metal, or even rubber may be substitutes. The fastening device 18 can be different such as a button, snap, Velcro, or directly adhered to the cap thus making it unable to be removed. The cap 20 can also be constructed in various ways. The cap 20 itself could be made of wood, plastic, metal, or rubber. The cap 20 does not need to be coated with the rubber and the resilient material 28 on top of the cap 20 can be different rubber, but still serve its function. The fastening device 24 can be altered in conjunction with the fastening device 18 on the practice pad 10. The adhesive 26 that holds the fastening device 24 can also be changed, but it needs to be strong to withhold great tension and strength.

In use, one would strike the practice pad 10 and the cap 20. By striking the cap 20 with both hands alternating, the individual is improving their accuracy and precision. Their technique is also improving and in the long run this repeated process will help in all areas of percussion. A person could use the practice pad 10 to practice in an area where loud noise would disturb others, such as a rehearsal, the bus, or a bedroom. If this is done correctly results will show and both technique and overall sound will be improved. The practice pad 10 can be placed on almost any surface such as a table, snare drum stand, generic practice pad stand, bed, the floor, and even on a drum because the non-skid material 16 on the bottom of the practice pad 10 will not damage the drum head. The interchangeable cap 20 will be able to be replaced by various sizes for different personal interests.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### SUMMARY OF THE INVENTION

In view of the forgoing disadvantages inherent in the known types of practice pad now present in the prior art, the present invention provides a new percussion pad that helps develop and improve accuracy construction wherein the same can be utilized for a percussionist to improve their accuracy which will improve technique thus improving their sound.

The general purpose of the present invention, which will be described subsequently in greater detail, is to provide a new percussion pad that helps develop and improve accuracy that has many of the advantages of the practice pad mentioned heretofore and many novel features that result in a new percussion practice pad that helps develop and improve accuracy which is not anticipated, rendered obvious, suggested, or even implied by any of the prior art practice pad, either alone or in any combination thereof.

To attain this, the present invention generally comprises a practice pad and a cap which can be attached and detached to the pad. This practice pad is made up of a circular piece of hard material with a circular piece of resilient material affixed to its upper side. There is a hole drilled in the middle of the practice pad which contains a fastening device from which to attach the cap. The cap is a cylindrical piece of hard material that may contain a piece of resilient material affixed to its upper side. The lower side has a threaded device that attaches the cap to the practice pad.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed therein are for the purpose of the description and should not be regarded as limiting.

A primary object of the present invention is to provide a percussion practice pad that helps develop and improve accuracy that will overcome the shortcomings of the prior art devices.

An object of the present invention is to provide a percussion practice pad that helps develop and improve accuracy for a percussionist to improve their accuracy which will improve technique thus improving their sound.

Another object is to provide a percussion practice pad that helps develop and improve accuracy that helps develop and improve the accuracy of the performer.

Another object is to provide a percussion practice pad that helps develop and improve accuracy that improves technique.

Another object is to provide a percussion practice pad that helps develop and improve accuracy that one may practice quietly.

Another object is to provide a percussion practice pad that helps develop and improve accuracy that is compact and portable.

Another object is to provide a percussion practice pad that helps develop and improve accuracy that can be used by all people, both novice and professional.

Another object is to provide a percussion practice pad that helps develop and improve accuracy that has various size caps which are interchangeable.

Another object is to provide a percussion practice pad that helps develop and improve accuracy that can benefit all percussionists and drummers regarding the genre of music they play.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

1. A percussion practice pad comprising:
2) The pad of claim 1 wherein said body is a flat piece of hard material having an upper and lower surface, said upper and lower surface having a center hole;
3) The pad of claim 1 wherein said body has an upper surface being recessed to the center hole;
4) The pad of claim 1 wherein said body has a piece of resilient material affixed to the upper surface;
5) The pad of claim 1 wherein said body has a piece of non-skid material affixed to the lower surface;
6) The pad according to claim 1 wherein the substrate is made of wood;
7) The pad according to claim 1 wherein the substrate is circular;
8) The pad according to claim 1 wherein the recess is less than the diameter of the hard material;

2.-8. (canceled)

9. A cap comprising of:
10) The cap of claim 9 wherein said body is used in accordance with claim 1;
11) The cap of claim 9 wherein said body is a cylindrical piece of hard material having a flat upper surface;
12) The cap of claim 9 wherein said body is a cylindrical piece of hard material having a lower surface with a means of fastening;
13) The cap of claim 9 wherein said body has a piece of resilient material affixed to the upper surface;
14) The cap according to claim 9 wherein the cap is made of metal;
15) The cap according to claim 9 wherein the cap is the same shape of said claim 1;
16) The cap according to claim 9 wherein the cap contains a fastening device which protrudes from the bottom surface.

10.-16. (canceled)
